(19) United States
(12) Patent Application Publication
(10) Pub. No.: US 2026/0080613 A1
(43) Pub. Date: Mar. 19, 2026

(54) HAND MODEL GEOMETRIC CONSTRAINTS

(71) Applicant: Snap Inc., Santa Monica, CA (US)

(72) Inventor: Blake Lucas, Culver City, CA (US)

(21) Appl. No.: 18/886,164

(22) Filed: Sep. 16, 2024

(51) Int. Cl. G06T 17/00; G06F 3/01; G06T 19/20

(52) U.S. Cl. CPC G06T 17/00; G06F 3/011; G06T 19/20; G06T 2200/24; G06T 2219/2004

(57) ABSTRACT

An XR system that applies geometric constraints to a hand model is provided. The XR system captures tracking data using sensors and generates a hand model with joints based on the data. The XR system transforms joint positions into a normalized coordinate system and applies constraints to the hand model generate anatomically correct hand models. The XR uses the hand models to generate a user interface and displays the user interface to the user.

### TECHNICAL FIELD

The present disclosure relates generally to user interfaces and, more particularly, to user interfaces used for extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term eXtended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, according to some examples.

FIG. 1B illustrates a further view of the head-wearable apparatus of FIG. 1A, according to some examples.

FIG. 2 illustrates a system in which the head-wearable apparatus is operably connected to a mobile device, according to some examples.

FIG. 3 illustrates a networked environment, according to some examples.

FIG. 4 is a block diagram showing a software architecture, according to some examples.

FIG. 5 is a diagrammatic representation of a machine in the form of a computer system, according to some examples.

FIG. 6 illustrates a collaboration diagram of components of an XR system, according to some examples.

FIG. 7 illustrates a geometric constraint method, according to some examples.

FIG. 8 illustrates a hand model, according to some examples.

FIG. 9A illustrates an uncorrected hand model, according to some examples.

FIG. 9B illustrates a corrected hand model, according to some examples.

FIG. 10A illustrates an uncorrected set of joints, according to some examples.

FIG. 10B illustrates a corrected set of joints, according to some examples.

FIG. 11A illustrates a set of uncorrected joints, according to some examples.

FIG. 11B illustrates a set of corrected joints, according to some examples.

FIG. 12A illustrates a machine-learning pipeline, according to some examples.

FIG. 12B illustrates training and use of a machine-learning program, according to some examples.

### DETAILED DESCRIPTION

XR systems with hand tracking offer significant utility across various domains. They enable natural and intuitive interactions within virtual and augmented environments, allowing users to manipulate digital objects and interfaces using their hands as they would in the physical world. This capability enhances user engagement and immersion in applications ranging from gaming and entertainment to professional training and design.

In educational and training scenarios, XR hand tracking systems can simulate complex tasks, allowing learners to practice procedures in a safe, controlled environment. For industrial and medical applications, these systems can provide precise control for remote operations or assist in delicate procedures. In the realm of creative arts and design, hand tracking enables more natural and expressive digital sculpting, painting, and modeling.

Hand tracking and modeling in XR applications face several challenges that impact user experience and interaction effectiveness. The current AI systems used for hand pose prediction lack temporal coherence, resulting in inconsistent and noisy hand representations over time. This frame-by-frame prediction approach fails to maintain consistent finger lengths, leading to unrealistic hand visualizations.

Some existing systems produce anatomically incorrect hand configurations, where joint angles may be invalid or fingers may bend in unnatural ways, such as backwards or crossing each other. This lack of plausible hand shapes diminishes the believability of hand representations in XR environments, negatively impacting user experience.

Another issue is the inefficient handling of hand occlusions and reappearances. Current systems may not optimally manage situations where hands fall out of view and then reappear, potentially treating each reappearance as a new user. This limitation extends to the adaptability of the system to individual user hand characteristics, as the current approach does not effectively learn and adapt to specific hand features of individual users over time.

These deficiencies in the existing technology result in less realistic and less stable hand representations in XR environments. Consequently, this can diminish the overall user experience and reduce the effectiveness of hand-based interactions in these applications. By addressing challenges such as maintaining consistent finger lengths, ensuring anatomically correct hand configurations, and adapting to individual user characteristics, XR systems with advanced hand tracking can provide more realistic and responsive interactions, thereby expanding their potential uses and benefits across various industries.

The methodologies described in this disclosure address these issues by implementing a multi-faceted approach that combines statistical learning, geometric constraints, and adaptive modeling to produce more accurate, stable, and believable hand representations.

In some examples, an XR system employs a running average of bone segment lengths to maintain consistent finger dimensions over time, while enforcing geometric constraints to ensure valid joint angles and prevent unnatural finger bending. By transforming joint positions into a normalized coordinate system based on palm orientation, the XR system simplifies the application of these constraints and allows for more efficient processing of hand poses.

In some examples, the XR system incorporates a model for finger twisting and adapts to individual user hand characteristics over time, resulting in more natural hand closure and personalized tracking. This comprehensive approach addresses key deficiencies in prior systems, ultimately enhancing the realism and effectiveness of hand-based interactions in virtual environments.

In some examples, the XR system captures, using one or more tracking sensors, tracking data of a hand of a user of the XR system and generates a hand model using the tracking data, the hand model including a set of joints. The XR system transforms the set of joints into a normalized coordinate system and applies a set of constraints to one or more joints of the set of joints. The XR system generates a user interface using the hand model and causes display of the user interface to the user.

In some examples, the XR system groups a subset of the set of joints into one or more sets of finger joints with each set of finger joints corresponding a finger of the hand model. The XR system defines a palm coordinate frame with an X axis, a Y axis, and a Z axis based on a palm orientation of the hand model and defines, using a base finger joint of each set of finger joints, a respective local coordinate frame for each set of finger joints.

In some examples, the XR system orients the Y axis of the palm coordinate frame to point through a set of finger joints corresponding to a middle finger of the hand model.

In some examples, the XR system translates one or more finger joints of one or more sets of finger joints to form a piecewise linear arrangement in a two-dimensional space in the respective local coordinate frame of the one or more sets of finger joints.

In some examples, the XR system, maintains a statistical model of a respective bone segment length for each bone segment of a set of bone segments.

In some examples, the XR system, calculates respective running averages of observed bone segment lengths for one or more bone segments of the set of bone segments, and adjusts current bone segment lengths for the one or more bone segments of the set of bone segments based on the respective running averages.

Other technical features may be readily apparent to one skilled in the art from the following figures, descriptions, and claims.

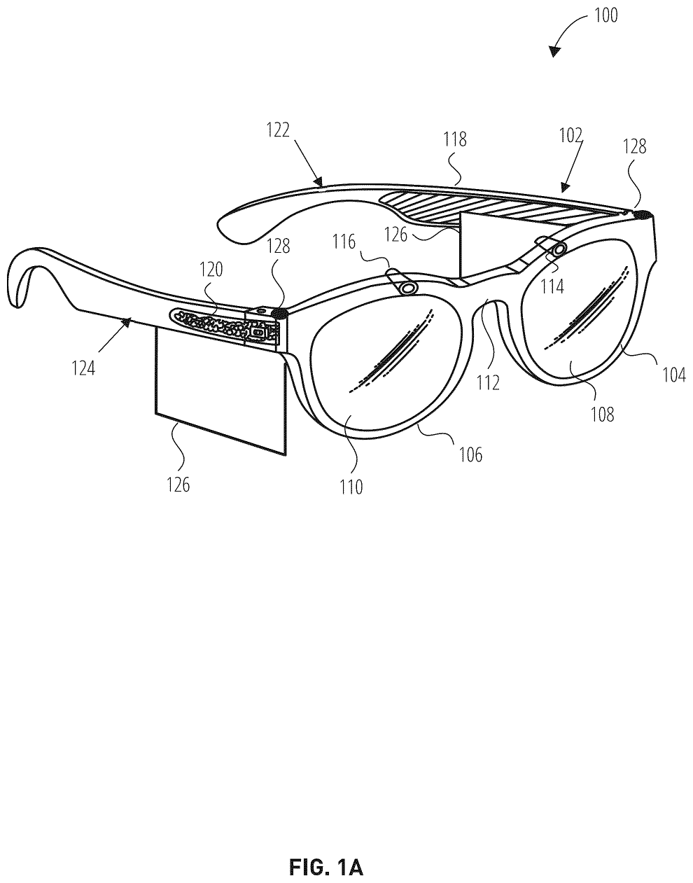

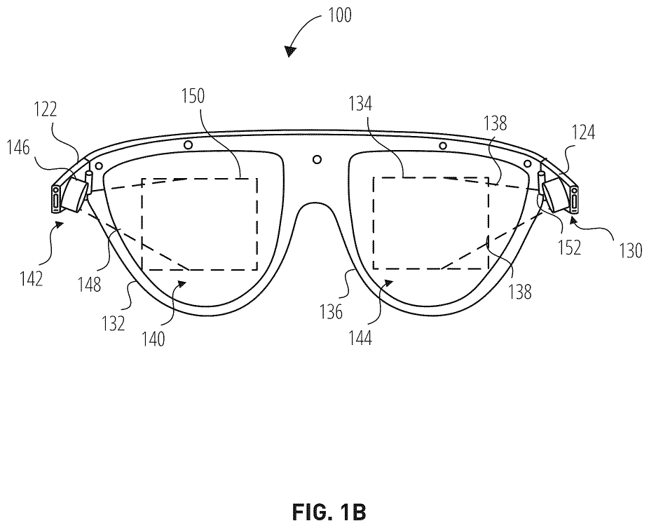

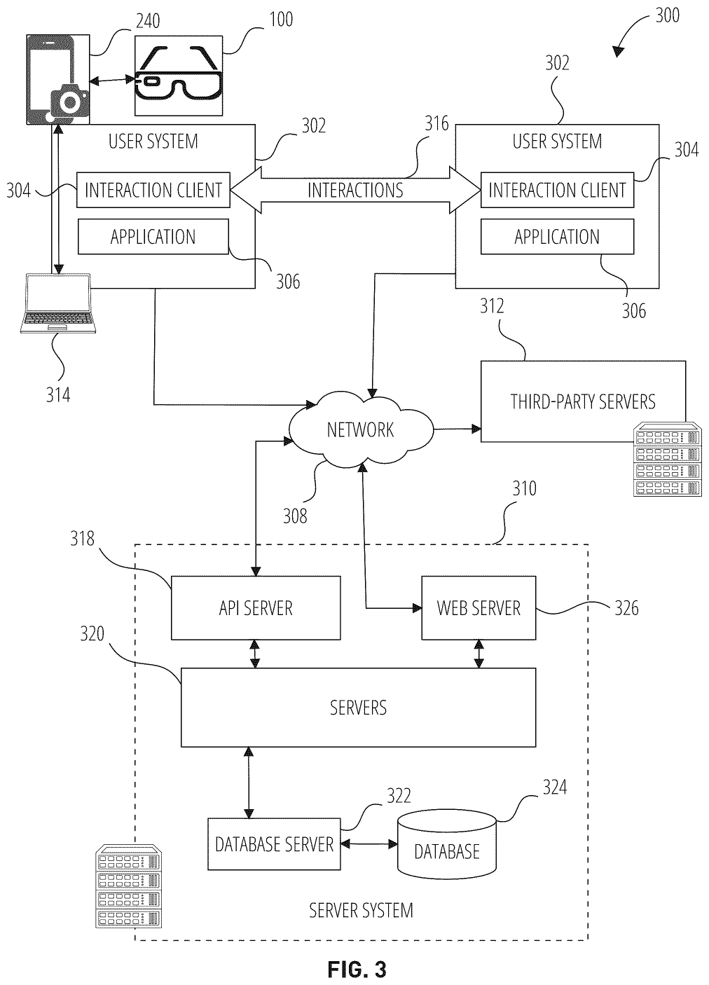

FIG. 1A is a perspective view of a head-wearable apparatus 100 according to some examples. The head-wearable apparatus 100 can be a client device of an XR system, such as a user system 302 of FIG. 3. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 500 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional (i.e., more than two) cameras.

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world scene.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

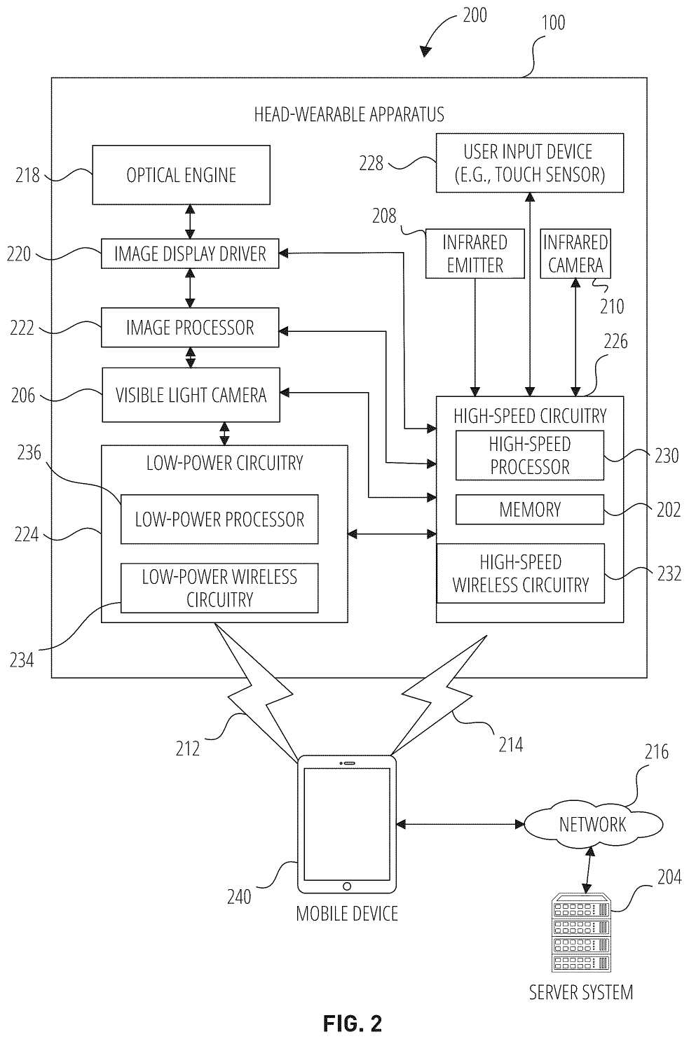

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, an optical engine of an XR system is incorporated into a lens that is in contact with a user's eye, such as a contact lens or the like. The XR system generates images of an XR experience using the contact lens.

In some examples, the head-wearable apparatus 100 comprises an XR system. In some examples, the head-wearable apparatus 100 is a component of an XR system including additional computational components. In some examples, the head-wearable apparatus 100 is a component in an XR system comprising additional user input systems or devices.

FIG. 2 illustrates a system 200 including a head-wearable apparatus 100 with a selector input device, according to some examples. FIG. 2 is a high-level functional block diagram of an example head-wearable apparatus 100 communicatively coupled to a mobile device 240 and various server systems 204.

The head-wearable apparatus 100 includes one or more cameras, each of which can be, for example, a visible light camera 206, an infrared emitter 208, and an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the optical engine 218. The optical engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The optical engine 218 is for presenting images and videos, including an image that can include a graphical user interface to a user of the head-wearable apparatus 100.

The image display driver 220 commands and controls the optical engine 218. The image display driver 220 can deliver image data directly to the optical engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the optical engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the optical engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data can be used for very limited purposes, such as identification verification. To ensure limited and authorized use of biometric information and other personally identifiable information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

FIG. 3 is a block diagram showing an example digital interaction system 300 for facilitating interactions and engagements (e.g., exchanging text messages, conducting text audio and video calls, or playing games) over a network. The digital interaction system 300 includes multiple user systems 302, each of which hosts multiple applications, including an interaction client 304 and other applications 306. Each interaction client 304 is communicatively coupled, via one or more networks including a network 308 (e.g., the Internet), to other instances of the interaction client 304 (e.g., hosted on respective other user systems), a server system 310 and third-party servers 312). An interaction client 304 can also communicate with locally hosted applications 306 using Applications Program Interfaces (APIs).

Each user system 302 can include multiple user devices, such as a mobile device 240, head-wearable apparatus 100, and a computer client device 314 that are communicatively connected to exchange data and messages.

An interaction client 304 interacts with other interaction clients 304 and with the server system 310 via the network 308. The data exchanged between the interaction clients 304 (e.g., interactions 316) and between the interaction clients 304 and the server system 310 includes functions (e.g., commands to invoke functions) and payload data (e.g., text, audio, video, or other multimedia data).

The server system 310 provides server-side functionality via the network 308 to the interaction clients 304. While certain functions of the digital interaction system 300 are described herein as being performed by either an interaction client 304 or by the server system 310, the location of certain functionality either within the interaction client 304 or the server system 310 can be a design choice. For example, it can be technically preferable to initially deploy particular technology and functionality within the server system 310 but to later migrate this technology and functionality to the interaction client 304 where a user system 302 has sufficient processing capacity.

The server system 310 supports various services and operations that are provided to the interaction clients 304. Such operations include transmitting data to, receiving data from, and processing data generated by the interaction clients 304. This data can include message content, client device information, geolocation information, digital effects (e.g., media augmentation and overlays), message content persistence conditions, entity relationship information, and live event information. Data exchanges within the digital interaction system 300 are invoked and controlled through functions available via user interfaces (UIs) of the interaction clients 304.

Turning now specifically to the server system 310, an Application Program Interface (API) server 318 is coupled to and provides programmatic interfaces to servers 320, making the functions of the servers 320 accessible to interaction clients 304, other applications 306 and third-party server 312. The servers 320 are communicatively coupled to a database server 322, facilitating access to a database 324 that stores data associated with interactions processed by the servers 320. Similarly, a web server 326 is coupled to the servers 320 and provides web-based interfaces to the servers 320. To this end, the web server 326 processes incoming network requests over the Hypertext Transfer Protocol (HTTP) and several other related protocols.

The Application Program Interface (API) server 318 receives and transmits interaction data (e.g., commands and message payloads) between the servers 320 and the user systems 302 (and, for example, interaction clients 304 and other application 306) and the third-party server 312. Specifically, the Application Program Interface (API) server 318 provides a set of interfaces (e.g., routines and protocols) that can be called or queried by the interaction client 304 and other applications 306 to invoke functionality of the servers 320. The Application Program Interface (API) server 318 exposes various functions supported by the servers 320, including account registration; login functionality; the sending of interaction data, via the servers 320, from a particular interaction client 304 to another interaction client 304; the communication of media files (e.g., images or video) from an interaction client 304 to the servers 320; the settings of a collection of media data (e.g., a narrative); the retrieval of a list of friends of a user of a user system 302; the retrieval of messages and content; the addition and deletion of entities (e.g., friends) to an entity relationship graph; the location of friends within an entity relationship graph; and opening an application event (e.g., relating to the interaction client 304).

The interaction client 304 provides a user interface that allows users to access features and functions of an external resource, such as a linked application 306, an applet, or a microservice. This external resource can be provided by a third party or by the creator of the interaction client 304.

The external resource can be a full-scale application installed on the user's system 302, or a smaller, lightweight version of the application, such as an applet or a microservice, hosted either on the user's system or remotely, such as on third-party servers 312 or in the cloud. These smaller versions, which include a subset of the full application's features, can be implemented using a markup-language document and can also incorporate a scripting language and a style sheet.

When a user selects an option to launch or access the external resource, the interaction client 304 determines whether the resource is web-based or a locally installed application. Locally installed applications can be launched independently of the interaction client 304, while applets and microservices can be launched or accessed via the interaction client 304.

If the external resource is a locally installed application, the interaction client 304 instructs the user's system to launch the resource by executing locally stored code. If the resource is web-based, the interaction client 304 communicates with third-party servers to obtain a markup-language document corresponding to the selected resource, which it then processes to present the resource within its user interface.

The interaction client 304 can also notify users of activity in one or more external resources. For instance, it can provide notifications relating to the use of an external resource by one or more members of a user group. Users can be invited to join an active external resource or to launch a recently used but currently inactive resource.

The interaction client 304 can present a list of available external resources to a user, allowing them to launch or access a given resource. This list can be presented in a context-sensitive menu, with icons representing different applications, applets, or microservices varying based on how the menu is launched by the user.

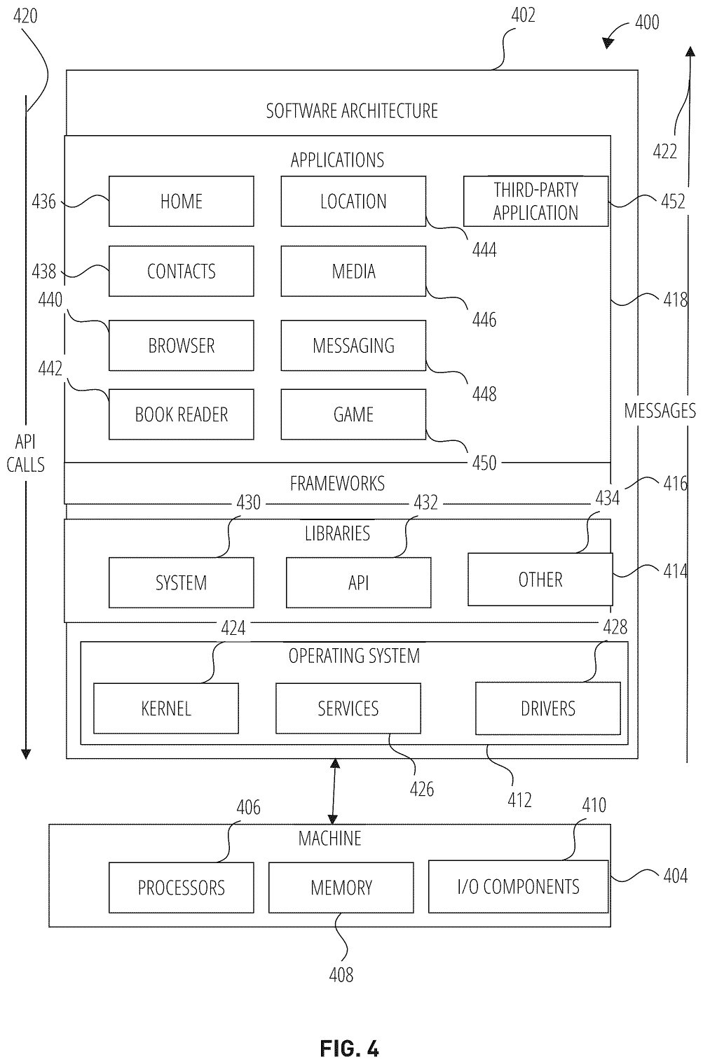

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality.

The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which can be specific to a particular operating system or platform.

In an example, the applications 418 can include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

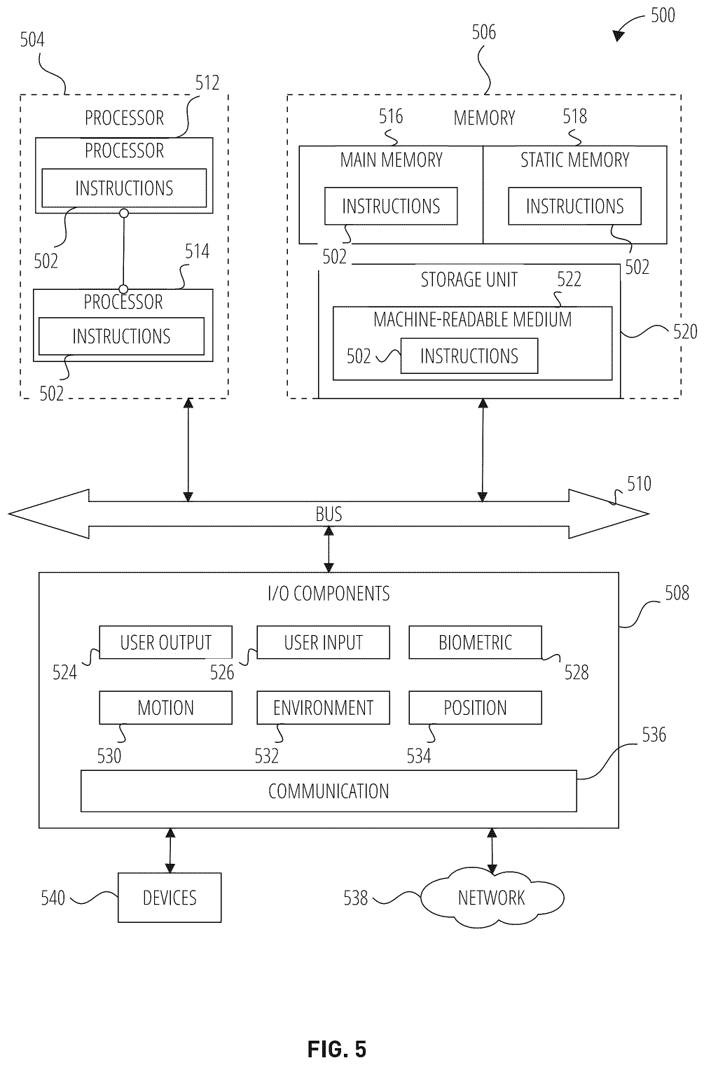

FIG. 5 is a diagrammatic representation of the machine 500 within which instructions 502 (e.g., software, a program, an application, an applet, an app, or other executable code) for causing the machine 500 to perform any one or more of the methodologies discussed herein can be executed. For example, the instructions 502 can cause the machine 500 to execute any one or more of the methods described herein. The instructions 502 transform the general, non-programmed machine 500 into a particular machine 500 programmed to carry out the described and illustrated functions in the manner described. The machine 500 can operate as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, can comprise the user system 302 or any one of multiple server devices forming part of the server system 310. In some examples, the machine 500 can also comprise both client and server systems, with certain operations of a particular method or algorithm being performed on the server-side and with certain operations of the method or algorithm being performed on the client-side.

The machine 500 can include one or more hardware processors 504, memory 506, and input/output I/O components 508, which can be configured to communicate with each other via a bus 510.

The processor 504 can comprise one or more processors such as, but not limited to, processor 512 and processor 514. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 506 includes a main memory 516, a static memory 518, and a storage unit 520, both accessible to the processor 504 via the bus 510. The main memory 506, the static memory 518, and storage unit 520 store the instructions 502 embodying any one or more of the methodologies or functions described herein. The instructions 502 can also reside, completely or partially, within the main memory 516, within the static memory 518, within machine-readable medium 522 within the storage unit 520, within at least one of the processor 504 (e.g., within the processor's cache memory), or any suitable combination thereof, during execution thereof by the machine 500.

The I/O components 508 can include a wide variety of components to receive input, provide output, produce output, transmit information, exchange information, capture measurements, and so on. The specific I/O components 508 that are included in a particular machine will depend on the type of machine. For example, portable machines such as mobile phones can include a touch input device or other such input mechanisms, while a headless server machine will likely not include such a touch input device. It will be appreciated that the I/O components 508 can include many other components that are not shown in FIG. 5. In various examples, the I/O components 508 can include user output components 524 and user input components 526. The user output components 524 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 can include biometric components 528, motion components 530, environmental components 532, or position components 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 302 can have a camera system comprising, for example, front cameras on a front surface of the user system 302 and rear cameras on a rear surface of the user system 302. The front cameras can, for example, be used to capture still images and video of a user of the user system 302 (e.g., “selfies”), which can then be modified with digital effect data (e.g., filters) described above. The rear cameras can, for example, be used to capture still images and videos in a more traditional camera mode, with these images similarly being modified with digital effect data. In addition to front and rear cameras, the user system 302 can also include a 360° camera for capturing 360° photographs and videos.

Moreover, the camera system of the user system 302 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 302 can also feature triple, quad, or even penta camera configurations on both the front and rear sides of the user system 302. These multiple cameras systems can include a wide camera, an ultra-wide camera, a telephoto camera, a macro camera, and a depth sensor, for example.

Communication can be implemented using a wide variety of technologies. The I/O components 508 further include communication components 536 operable to couple the machine 500 to a Network 538 or devices 540 via respective coupling or connections. For example, the communication components 536 can include a network interface component or another suitable device to interface with the Network 538. In further examples, the communication components 536 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 can be another machine or any of a wide variety of peripheral devices (e.g., a peripheral device coupled via a USB).

Moreover, the communication components 536 can detect identifiers or include components operable to detect identifiers. For example, the communication components 536 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 536, such as location via Internet Protocol (IP) geolocation, location via Wi-Fi® signal triangulation, location via detecting an NFC beacon signal that can indicate a particular location, and so forth.

The various memories (e.g., main memory 516, static memory 518, and memory of the processor 504) and storage unit 520 can store one or more sets of instructions and data structures (e.g., software) embodying or used by any one or more of the methodologies or functions described herein. These instructions (e.g., the instructions 502), when executed by processor 504, cause various operations to implement the disclosed examples.

The instructions 502 can be transmitted or received over the Network 538, using a transmission medium, via a network interface device (e.g., a network interface component included in the communication components 536) and using any one of several well-known transfer protocols (e.g., hypertext transfer protocol (HTTP)). Similarly, the instructions 502 can be transmitted or received using a transmission medium via a coupling (e.g., a peer-to-peer coupling) to the devices 540.

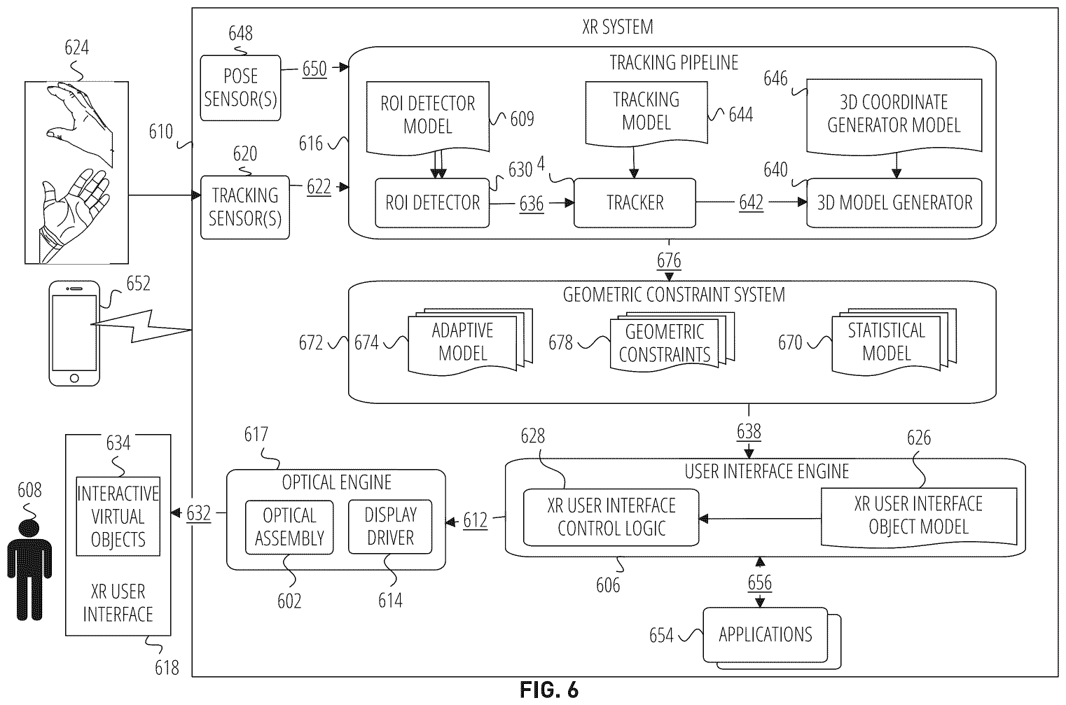

FIG. 6 illustrates a collaboration diagram of components of an XR system 610, such as head-wearable apparatus 100 of FIG. 1A, using hand-tracking for user input, according to some examples.

The XR system 610 uses corrected tracking data 638 and to provide continuous real-time input modalities to a user 608 of the XR system 610 where the user 608 interacts with one or more XR user interface 618. Using the hand-tracking input modalities, the XR system 610 generates user interface input/output (UI I/O) data 656 that are used by one or more applications 654 to generate one or more one or more interactive virtual objects 634 displayed as part of the one or more XR user interface 618.

The applications 654 are applications that are executed by the XR system 610 and generate application user interfaces that provide features such as, but not limited to, maintenance guides, interactive maps, interactive tour guides, tutorials, and the like. The applications 654 can also be entertainment applications such as, but not limited to, video games, interactive videos, and the like.

While in use, the XR system 610 uses one or more tracking sensors 620 to detect and record a position, orientation, and gestures of the hands 624 of the user 608. This can involve capturing the speed and trajectory of hand movements, recognizing specific hand poses, and determining the relative positioning of the hands 624 in the three-dimensional space of a real-world environment.

In some examples, the one or more tracking sensors 620 comprise an array of optical sensors capable of capturing a wide range of hand movements and gestures in real-time as images. These sensors can include Red Green and Blue (RGB) cameras that capture images of the hands 624 of the user 608 using light having a broad wavelength spectrum, such as natural light provided by the real-world environment or artificial illumination created by one or more incandescent lamps, LED lamps, or the like provided by the XR system 610. In some examples, the one or more tracking sensors 620 can include infrared cameras that capture images of the hands 624 of the user 608 using energy in the infrared radiation (IR) spectrum. The IR energy can be supplied by one or more IR emitters of the XR system 610.

In some examples, the one or more tracking sensors 620 comprise depth-sensing cameras that utilize structured light or time-of-flight technology to create a three-dimensional model of the hands 624 of the user 608. This allows the XR system 610 to detect intricate gestures and finger movements with high accuracy.

In some examples, the one or more tracking sensors 620 comprise ultrasonic sensors that emit sound waves and measure the reflection off the hands 624 of the user 608 to determine their location and movement in space.

In some examples, the one or more tracking sensors 620 comprise electromagnetic field sensors that track the movement of the hands 624 of the user 608 by detecting changes in an electromagnetic field generated around the user 608.

In some examples, the one or more tracking sensors 620 include capacitive sensors embedded in gloves worn by the user 608. These sensors detect hand movements and gestures based on changes in capacitance caused by finger positioning and orientation.

In some examples, the XR system 610 includes one or more pose sensors 648 such as an Inertial Measurement Unit (IMU) and the like, that track the orientation and movements of the XR system of the user 608. The one or more pose sensors 648 are used to determine Six Degrees of Freedom (6DoF) data of movement of the XR system 610 in three-dimensional space. Specifically, the 6DoF data encompasses three translational movements along the x, y, and z axes (forward/back, up/down, left/right) and three rotational movements (pitch, yaw, roll) included in pose data 650. In the context of XR, 6DoF data is allows for the tracking of both position and orientation of an object or user in 3D space.

In some examples, the one or more pose sensors 648 include one or more cameras that capture images of the real-world environment. The images are included in the pose data 650. The XR system 610 uses the images and photogrammetric methodologies to determine 6DoF data of the XR system 610.

In some examples, the XR system 610 uses a combination of an IMU and one or more cameras to determine 6DoF for the XR system 610.

The XR system 610 uses a tracking pipeline 616 including a Region Of Interest (ROI) detector 630, a tracker 604, and a 3D model generator 640, to generate tracking data 676 using the tracking data 622 and the pose data 650.

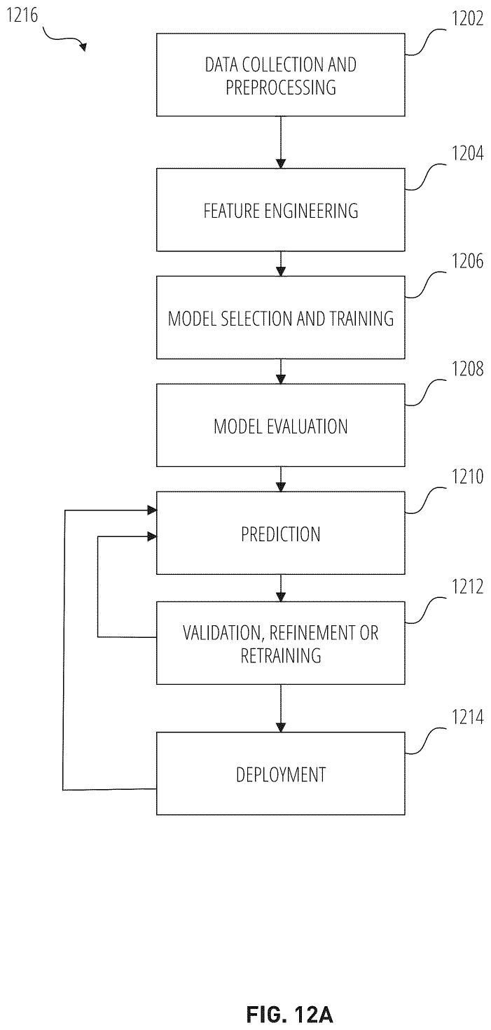

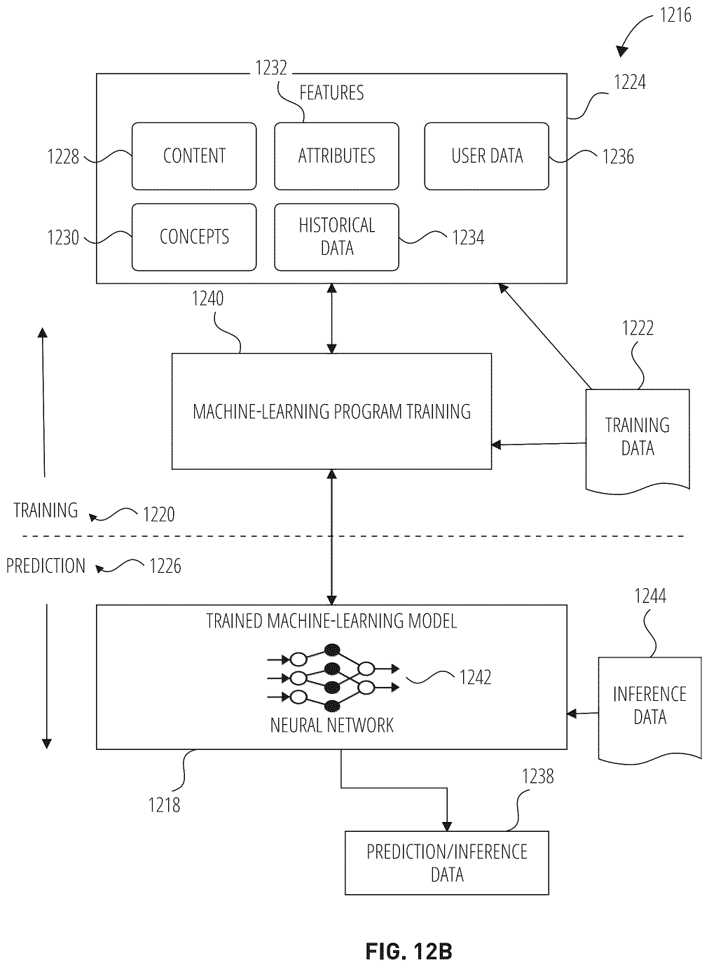

The ROI detector 630 uses a ROI detector model 609 to detect a region in the real world environment that includes one or more of the hands 624 of the user 608. The ROI detector model 609 is trained to recognize those portions of the real-world environment that include a user's hands as more fully described in reference to FIG. 12A and FIG. 12B. The ROI detector 630 generates ROI data 636 indicating which portions of the tracking data 622 include one or more hands of the user 608 and communicates the ROI data 636 to the tracker 604.

The tracker 604 uses a tracking model 644 to generate 2D tracking data 642. The tracker 604 uses the tracking model 644 to recognize landmark features at locations on the one or both hands 624 of the user 608 captured in the tracking data 622 and within the ROI identified by the ROI detector 630. The tracker 604 extracts landmarks of the one or both hands 624 of the user 608 from the tracking data 622 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The tracking model 644 operates on the landmarks to generate the 2D tracking data 642 that includes a sequence of skeletal models of one or more hands of the user 608. The tracking model 644 is trained to generate the 2D tracking data 642 as more fully described in reference to FIG. 12A and FIG. 12B. The tracker communicates the 2D tracking data 642 to the 3D model generator 640.

The 3D model generator 640 receives the 2D tracking data 642 and generates tracking data 676 using the 2D tracking data 642, the pose data 650, and a 3D coordinate generator model 646. For example, the 3D model generator 640 determines a reference position in the real-world environment for the XR system 610. The 3D model generator 640 uses a 3D coordinate generator model 646 that operates on the 2D tracking data 642 to generate the tracking data 676. The 3D coordinate generator model 646 is trained to generate the tracking data 676 as more fully described in reference to FIG. 12A and FIG. 12B.

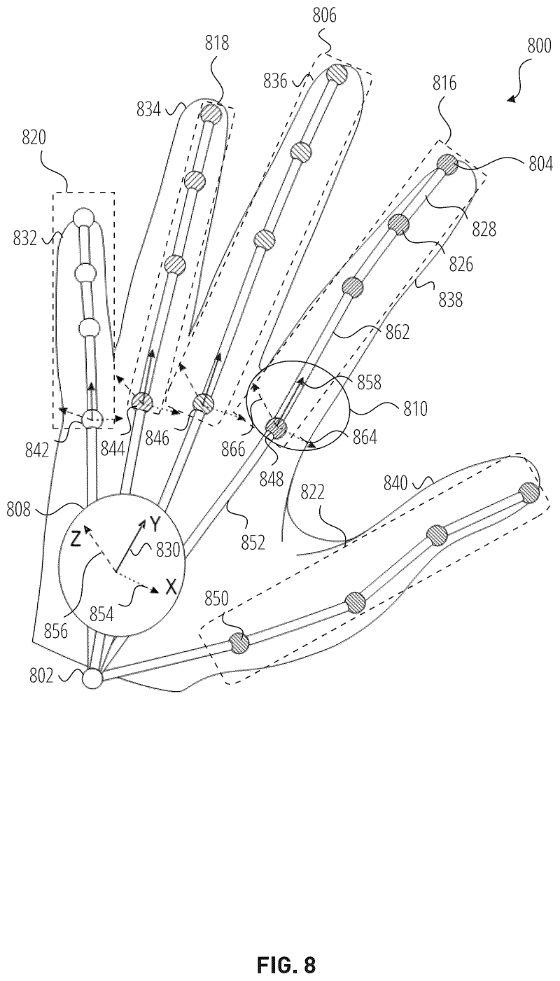

In some examples, the tracker 604 generates the tracking data 676 using photogrammetry methodologies to create 3D hand models of the hands 624 of the user 608 from the 2D tracking data 642 by capturing overlapping pictures of the hands of the user 608 from different angles. In some examples, the 2D tracking data 642 includes multiple images taken from different angles, which are then processed to generate the 3D hand models that are included in the tracking data 676. In some examples, the XR system 610 uses the pose data 650 captured by one or more pose sensors 648 to determine an angle or position of the XR system 610 as an image is captured of the hands of the user 608. A hand model of the tracking data 676 includes a set of joints and a set of bone segments as more fully described in reference to FIG. 8.

In some examples, images in the tracking data 622 are processed by an image processor to enhance the images for better clarity and contrast, making it easier for the XR system 610 to extract features from the tracking data 622. In some examples, the image processor uses image enhancement methodologies such as, but not limited to: histogram equalization, which adjusts the contrast of an image by redistributing the intensity values; Gaussian smoothing, which reduces noise and detail by averaging pixel values with a Gaussian kernel; unsharp mask filtering, which enhances edges by subtracting a blurred version of the image from the original; Wiener filtering, which removes noise and deblurs images by accounting for both the degradation function and the statistical properties of noise; Contrast-Limited Adaptive Histogram Equalization (CLAHE), which improves local contrast and enhances the definition of edges in an image; median filtering, which reduces noise by replacing each pixel's value with the median value of the intensities in its neighborhood; point operations, which apply the same transformation to each pixel based on its original value, such as intensity transformations; spatial filtering, which involves convolution of the image with a kernel to achieve effects like blurring or sharpening; and the like.

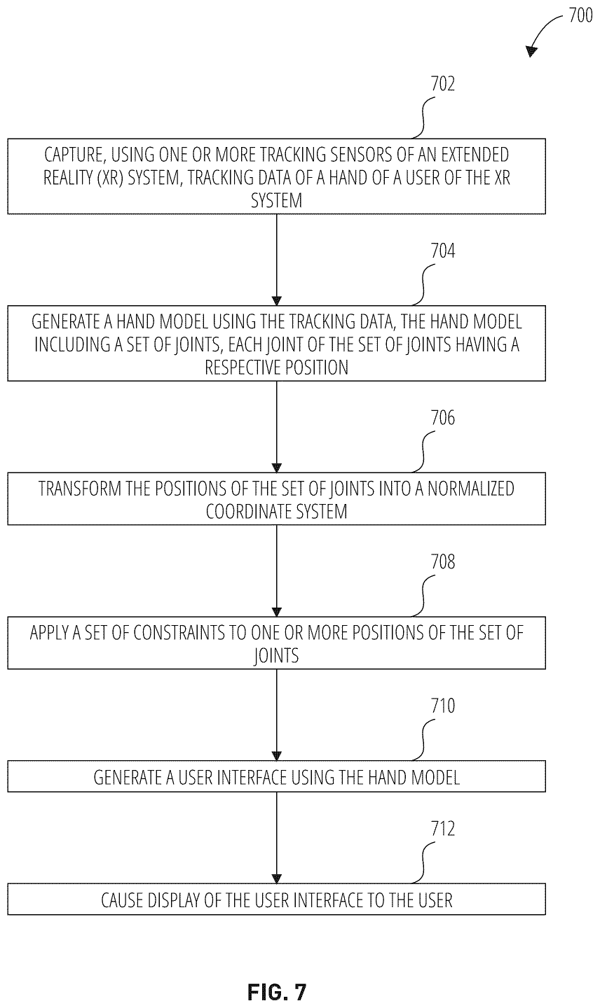

The XR system 610 uses a geometric constraint system 672 including an adaptive model 674 and a statistical model 670 to generate the corrected tracking data 638 from the tracking data 676. The geometric constraint system 672 receives the tracking data 676 and applies a set of geometric constraints 678 to the hand models included in the tracking data 676 to generate corrected hand models included in the corrected tracking data 638 in a process more fully described in reference to FIG. 7. In some examples, the geometric constraint system 672 uses an adaptive model 674 and a statistical model 670 to adapt the corrected hand models to a specific user as more fully described in reference to FIG. 7.

The XR system 610 generates the XR user interface 618 provided to the user 608 within an XR environment and implements one or more user input modalities using the hand models in the corrected tracking data 638 received from the geometric constraint system 672. The XR user interface 618 includes one or more interactive virtual objects 634 that the user 608 can interact with user input modalities that use the hand models.

The user interface engine 606 includes XR user interface control logic 628 comprising a dialog script or the like that specifies a user interface dialog implemented by the XR user interface 618. The XR user interface control logic 628 also comprises one or more actions that are to be taken by the XR system 610 based on detecting various dialog events such as user inputs input by the user 608 using the XR user interface 618 by making hand gestures, using a virtual cursor, by Direct Manipulation of Virtual Objects (DMVO), and the like. The user interface engine 606 further includes an XR user interface object model 626. The XR user interface object model 626 includes 3D coordinate data of the one or more interactive virtual objects 634. The XR user interface object model 626 also includes 3D graphics data of the one or more interactive virtual objects 634. The 3D graphics data are used by an optical engine 617 to generate the XR user interface 618 for display to the user 608.

The user interface engine 606 generates XR user interface data 612 using the XR user interface object model 626. The XR user interface data 612 includes image data of the one or more interactive virtual objects 634 of the XR user interface 618. The user interface engine 606 communicates the XR user interface data 612 to a display driver 614 of an optical engine 617 of the XR system 610. The display driver 614 receives the XR user interface data 612 and generates display control signals using the XR user interface data 612. The display driver 614 uses the display control signals to control the operations of one or more optical assemblies 602 of the optical engine 617. In response to the display control signals, the one or more optical assemblies 602 generate an XR user interface graphics display 632 of the XR user interface 618 that are provided to the user 608.

In some examples, the XR system 610 is operably connected to a mobile device 652. The user 608 can use the mobile device 652 to configure the XR system 610. In some examples, the mobile device 652 functions as an alternative input modality.

In some examples, an XR system performs the functions of the tracking pipeline 616, the user interface engine 606, and the optical engine 617 utilizing various APIs and system libraries.

FIG. 7 illustrates an example geometric constraint method 700, according to some examples. An XR system, such as XR system 610 of FIG. 6, uses the geometric constraint method 700 to apply a set of geometric constraints to a set of joints of a hand model, such as hand model 800 of FIG. 8. Although the example geometric constraint method 700 depicts a particular sequence of operations, the sequence may be altered without departing from the scope of the present disclosure. For example, some of the operations depicted may be performed in parallel or in a different sequence that does not materially affect the function of the geometric constraint method 700. In other examples, different components of an XR system that implements the geometric constraint method 700 may perform functions at substantially the same time or in a specific sequence.

In operation 702, the XR system captures, using one or more tracking sensors of the XR system, tracking data of a hand of a user of the XR system. For example, in reference to FIG. 6, the XR system captures tracking data of one or more of the user's hands 624 using one or more tracking sensors 620, such as visible light cameras, infrared cameras, depth-sensing cameras, or other sensors capable of detecting hand movements and gestures in real-time. In some examples, the one or more tracking sensors 620 include an array of optical sensors that capture images of the user's hands 624 using light in various wavelength spectra, including visible light and infrared. In some examples, the one or more tracking sensors 620 comprise depth-sensing cameras that utilize structured light or time-of-flight technology to create a three-dimensional model of the user's hands 624. The captured tracking data one or more tracking sensors 620 can include information about the position, orientation, and gestures of the user's hand in three-dimensional space. In some examples, the XR system captures pose data 650 from one or more pose sensors 648. The pose data 650 can be used to determine a coordinate frame for the XR system within a real-world environment.

In operation 704, the XR system generates a hand model using the tracking data, the hand model including a set of joints, each joint of the set of joints having a respective position. For example, in reference to FIG. 8, a hand model 800 includes a set of joints. In some examples, the set of joints correspond to 21 landmarks on a user's hand in 3D space along with a chirality (left or right) of the hand corresponding to the hand model 800. The landmarks are used to construct a set of joints. The joints include a wrist joint 802 that corresponds to the wrist of the hand and sets of finger joints including one or more finger joints, such as finger joint 804 and finger joint 826 of the set of finger joints 816. The set of joints also include a set of sets of finger joints where each set of finger joints corresponds to a respective finger of the user's hand. For example, a set of finger joints 820 corresponds to a little finger 832, a set of finger joints 818 corresponds to a ring finger 834, a set of finger joints 806 corresponds to a middle finger 836, a set of finger joints 816 corresponds to an index finger 838, and a set of finger joints 822 corresponds to a thumb 840.

Each set of finger joints includes a base finger joint, such as base finger joint 842 of the set of finger joints 820. In a like manner, set of finger joints 818 includes base finger joint 844, set of finger joints 806 includes base finger joint 844, set of finger joints 806 includes base finger joint 846, set of finger joints 816 includes base finger joint 848, and set of finger joints 822 includes base finger joint 850.

The hand model 800 also includes a set of bone segments that join the joints. For example, bone segment 828 joins finger joint 804 to finger joint 826. In like manner, bone segment 852 joins base finger joint 848 to the wrist joint 802.

In some examples, the XR system maintains a statistical model 670 (of FIG. 6) of bone segment lengths for each bone segment in the hand model. This involves calculating a running average of the observed bone segment lengths over time. As new tracking data is captured across multiple frames of tracking data, the XR system updates the running average for each bone segment in the statistical model 670. Current bone segment lengths in the hand model 800 are then adjusted based on these running averages. This statistical approach allows the XR system to maintain consistent bone segment dimensions, and thus finger dimensions of the user's hand, even as hand poses change, reducing noise and improving stability in the hand representation by the hand model 800 over time. By applying this bone length regularization consistently, the XR system ensures anatomical correctness and temporal coherence of the hand model across multiple frames of tracking data.

In operation 706, the XR system transforms the positions of the set of joints into a normalized coordinate system. In some examples, base finger joint 842, base finger joint 844, base finger joint 846, base finger joint 848, base finger joint 850, and the wrist joint 802 define a palm of the hand model. The XR system uses the base finger joints and the wrist joint 802 determine a hand model orientation. A plane is fit through the base finger joints and the wrist joint 802 and a palm point is computed as the weighted average of the locations of the base finger joints and the wrist joint 802. A normal direction of the plane is oriented to point out of the top of the hand determined by whether the thumb 840 is to the left or right of the palm point. A chirality of the hand is used to disambiguate whether the thumb 840 should be to the left or right of the palm point. The plane defines a palm coordinate frame 808 with an X axis 854, a Y axis 830, and a Z axis 856 based on the palm orientation of the hand model 800. In some examples, the Y axis 830 of the palm coordinate frame 808 is oriented to point through set of finger joints 806 corresponding to the middle finger 836 of the hand model.

The palm coordinate frame 808 and the base finger joints are used to define a respective local coordinate frame for each set of finger joints as illustrated by local coordinate frame 810 associated with base finger joint 848 of set of finger joints 806. For example, local coordinate frame 810 is constructed for the set of finger joints 816 corresponding to the index finger 838, rooted at the base finger joint 848 with a Y axis 858 pointing in the direction of a proximal bone segment 862. The Z axis 866 is chosen to be orthogonal to the Y axis 858 and also pointing out the top of the hand model 800. The X axis 864 is chosen to be orthogonal to both the Y axis 858 and the Z axis 866.

The palm coordinate frame 808 and the local coordinate frames are used to transform the positions of the set of joints into a normalized coordinate system so the XR system can more efficiently apply geometric constraints and corrections to ensure anatomically correct and stable hand representations.

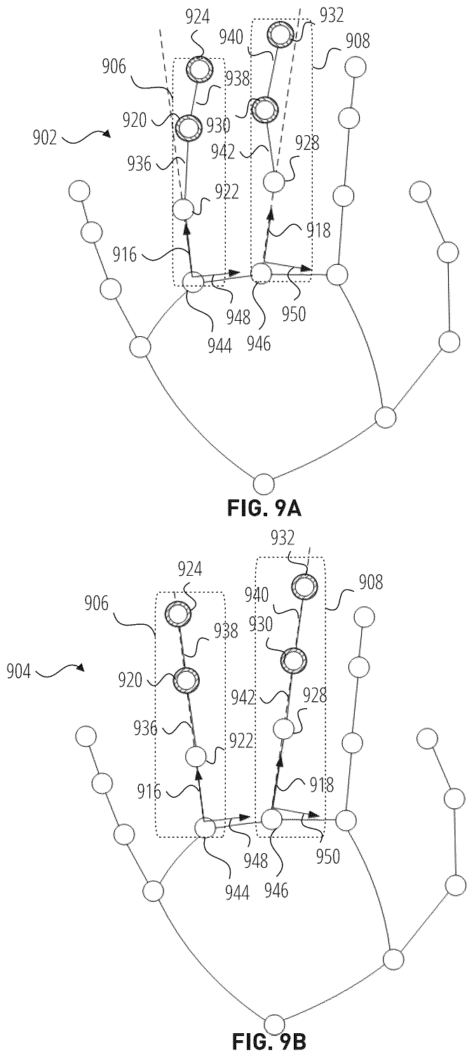

In operation 708, the XR system applies a set of geometric constraints 678 (of FIG. 6) to one or more positions of joints of the set of joints of the hand model. For example, in reference to FIG. 9A and FIG. 9B, the XR system translates one or more finger joints of one or more sets of finger joints to form a piecewise linear arrangement in a two-dimensional space in the respective local coordinate frame of the set of finger joints. As illustrated in FIG. 9A, uncorrected hand model 902 includes a first set of finger joints 906 having one or more misaligned finger joints, namely finger joint 920 and finger joint 924. The XR system rotates bone segment 936 around finger joint 922 in a plane or two-dimensional space defined by the X axis 948 and Y axis 916 of a local coordinate frame associated with base finger joint 944 until finger joint 920 is aligned with the Y axis 916 of the local coordinate frame associated with base finger joint 944. This translates finger joint 920 to be in piecewise linear arrangement with base finger joint 944 and finger joint 922 as shown by partially corrected hand model 904 of FIG. 9B. The XR system rotates bone segment 938 around finger joint 920 in the two-dimensional space until finger joint 924 is also in alignment with Y axis 916. This results in finger joint 924, finger joint 920, finger joint 922, and base finger joint 944 of set of finger joints 906 being in a piecewise linear arrangement with arrangement with each other as illustrated by partially corrected hand model 904 of FIG. 9B.

In a similar manner, uncorrected hand model 902 includes a second set of finger joints 908 having one or more misaligned finger joints, namely finger joint 932 and finger joint 930. The XR system rotates bone segment 942 around finger joint 928 in a plane or two-dimensional space defined by the X axis 950 and Y axis 918 of a local coordinate frame associated with base finger joint 946 until finger joint 930 is aligned with the Y axis 918 of the local coordinate frame associated with base finger joint 946. This translates finger joint 930 to be in piecewise linear arrangement with base finger joint 946 and finger joint 928 as shown by partially corrected hand model 904 of FIG. 9B. The XR system rotates bone segment 940 around finger joint 930 in the two-dimensional space until finger joint 932 is also in alignment with Y axis 918. This results in finger joint 932, finger joint 930, finger joint 928, and base finger joint 946 of set of finger joints 906 being in a piecewise linear arrangement with arrangement with each other as illustrated by partially corrected hand model 904 of FIG. 9B.

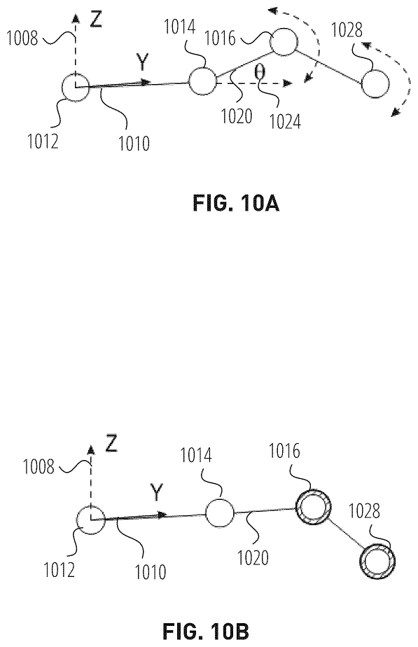

In reference to FIG. 10A and FIG. 10B, once the finger joints of a set of finger joints are aligned along a Y axis of a local coordinate frame, uncurling of the sets of finger joints can be expressed by rotations of one or more bone segments along an X axis of a local coordinate frame associated with a base finger joint 1012 of the set of finger joints in a plane or two-dimensional space defined by a Z axis 1008 and Y axis 1010 of the local coordinate frame. This is a simplification that avoids ambiguities of modeling finger curl along two rotational axes. For example, bone segment 1020 is rotated around finger joint 1014 until angle 1024 between the bone segment 1020 and the Y axis 1010 satisfied by a geometric constraint of maintaining angle 1024 within a threshold range (e.g., between 0 and 170 degrees). This rotation translates finger joint 1016 and finger joint 1028 in the two-dimensional space taking on a more natural finger curl. The corrective transformation is applied any finger joints downstream in the kinematic chain until all finger joints in a set of finger joints are processed.

In some examples, the XR system enforces anatomically correct ranges of motion for each joint of a set of joints. For example, by enforcing a constraint that the sum of all joint angles along a set of finger joints does not exceed 180 degrees, otherwise the set of finger joints would self-intersect.

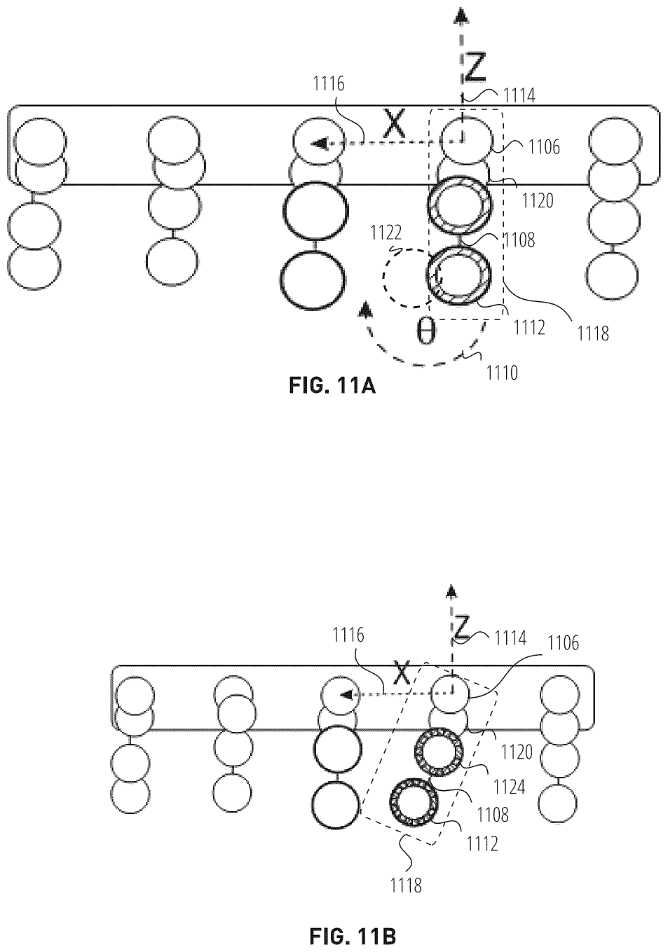

In some examples, in reference to FIG. 11A and FIG. 11B, a set of finger joints 1118 are translated in a plane or two-dimensional space defined by an X axis 1116 a Z axis 1114 of a local coordinate frame of the set of finger joints 1118. This is done by rotating 1110 the bone segments, such as bone segment 1108, and non-base finger joints, such as finger joint 1112, finger joint 1124, and finger joint 1120, of the set of finger joints around a Y axis of the local coordinate frame associated with the base finger joint 1106. This translates the finger joint 1112 corresponding to a fingertip of a finger of the user's hand to be closer to an original finger joint position 1122. This is to account for the natural twisting inward of the fingers of a user's hand as the fingers of the user's hand are curled toward the palm of the user's hand during a hand closure.

In some examples, rotation constraints are enforced to prevent the set of finger joints from curling back towards the top of the hand model, violating constraints from previous processing.

In some examples, the XR system uses a finger twisting model to determine a natural hand closure towards a point of the palm of the user's hand. The training and use of the twisting model is more fully described in reference to FIG. 12A and FIG. 12B.

In some examples, the XR system uses an adaptive model 674 (of FIG. 6) to adapt the hand model 800 to individual user characteristics over time to improve accuracy and consistency of hand tracking. This adaptation process involves updating various parameters of the hand model 800 based on observed hand configurations across multiple tracking frames within a tracking session. For example, the XR system adjusts bone lengths, joint angle limits, and hand shape parameters to better match the unique anatomical features of an individual user's hand. By maintaining and updating these user-specific hand statistics, the XR system can provide a more personalized and accurate hand tracking experience. This adaptive approach allows the XR system to account for variations in hand size, finger length, and range of motion among different users, resulting in more natural and believable hand representations in the virtual environment.

In some examples, the adaptation process continues over multiple tracking sessions, with the XR system retaining user-specific hand statistics for a predetermined time period (e.g., 30 seconds) between tracking sessions. This allows for seamless handling of hand occlusions and reappearances, maintaining consistency in the hand representation even when the user's hand temporarily moves out of view. If a user's hand reappears within this time period, the XR system continues to use the previously learned statistics, ensuring a smooth and consistent user experience.

In operation 710, the XR system generates an XR user interface using the hand model and, in operation 712, the XR system causes display of the XR user interface to the user. The XR user interface can use the hand model 800 in several ways within the XR user interface such as, but not limited to:
Mesh Generation: The XR system generates a mesh representation of a hand of the user based on the constrained and adapted hand model. This mesh is used for visual rendering of the hand in the XR user interface.
User Interface Overlay: A hand model can be used to display a user interface on a virtual surface associated with a tracked hand. For example, controls for Wi-Fi, speakers, and other functions can be displayed as a virtual watch-style interface on the back of the palm of the user's hand.
Visual Feedback: A mesh representation can be used for overlaying on the user's real hand or displaying fingertip positions in an XR user interface. This provides visual feedback to the user about their hand position and gestures.
Occlusion Calculation: A hand model can be used for calculating occlusions in the XR user interface. This allows virtual objects to be correctly obscured by the user's hand when appropriate, enhancing the realism of the virtual experience.
Gesture Recognition: A hand model enables the XR system to detect specific gestures, such as pinching or clicking, which can be used as a user input modality for interactions within the XR user interface.
Direct Manipulation of Virtual Objects (DMVO): A hand model can be used to detect direct interactions with interactive virtual objects by the user's hand using hand movements such as, but not limited to, grasping, pinching, and moving the interactive virtual objects in the XR user interface.
Virtual Cursors: A hand model can be used to provide virtual cursors, such as a raycast cursor or the like, associated with the user's hand. The virtual cursors can be used to interact with interactive virtual objects by using hand movements to perform actions including, but not limited to, targeting, selecting, and moving the interactive virtual objects in the XR user interface.

### Machine-Learning Pipeline

FIG. 12B is a flowchart depicting a machine-learning pipeline 1216, according to some examples. The machine-learning pipeline 1216 can be used to generate a trained machine-learning model 1218 such as, but not limited to a finger twisting model, a ROI detector model 609 of FIG. 6, a tracking model 644 of FIG. 6, and a 3D coordinate generator model 646 of FIG. 6, and the like, to perform various operations associated with generating an XR user interface an XR system by an XR system.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 1218 can include multiple phases that form part of the machine-learning pipeline 1216, including for example the following phases illustrated in FIG. 12A:
Data collection and preprocessing 1202: This phase can include acquiring and cleaning data to ensure that it is suitable for use in the machine learning model. This phase can also include removing duplicates, handling missing values, and converting data into a suitable format.
Feature engineering 1204: This phase can include selecting and transforming the training data 1222 to create features that are useful for predicting the target variable.

Feature engineering can include (1) receiving features 1224 (e.g., as structured or labeled data in supervised learning) and/or (2) identifying features 1224 (e.g., unstructured or unlabeled data for unsupervised learning) in training data 1222.
Model selection and training 1206: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 1208: This phase can include evaluating the performance of a trained model (e.g., the trained machine-learning model 1218) on a separate testing dataset. This phase can help determine if the model is overfitting or underfitting and determine whether the model is suitable for deployment.
Prediction 1210: This phase involves using a trained model (e.g., trained machine-learning model 1218) to generate predictions on new, unseen data.
Validation, refinement or retraining 1212: This phase can include updating a model based on feedback generated from the prediction phase, such as new data or user feedback.
Deployment 1214: This phase can include integrating the trained model (e.g., the trained machine-learning model 1218) into a more extensive system or application, such as a web service, mobile app, or IoT device. This phase can involve setting up APIs, building a user interface, and ensuring that the model is scalable and can handle large volumes of data.

FIG. 12B illustrates further details of two example phases, namely a training phase 1220 (e.g., part of the model selection and trainings 1206) and a prediction phase 1226 (part of prediction 1210). Prior to the training phase 1220, feature engineering 1204 is used to identify features 1224. This can include identifying informative, discriminating, and independent features for effectively operating the trained machine-learning model 1218 in pattern recognition, classification, and regression. In some examples, the training data 1222 includes labeled data, known for pre-identified features 1224 and one or more outcomes. Each of the features 1224 can be a variable or attribute, such as an individual measurable property of a process, article, system, or phenomenon represented by a data set (e.g., the training data 1222). Features 1224 can also be of different types, such as numeric features, strings, and graphs, and can include one or more of content 1228, concepts 1230, attributes 1232, historical data 1234, and/or user data 1236, merely for example.

In training phase 1220, the machine-learning pipeline 1216 uses the training data 1222 to find correlations among the features 1224 that affect a predicted outcome or prediction/inference data 1238.

With the training data 1222 and the identified features 1224, the trained machine-learning model 1218 is trained during the training phase 1220 during machine-learning program training 1240. The machine-learning program training 1240 appraises values of the features 1224 as they correlate to the training data 1222. The result of the training is the trained machine-learning model 1218 (e.g., a trained or learned model).

Further, the training phase 1220 can involve machine learning, in which the training data 1222 is structured (e.g., labeled during preprocessing operations). The trained machine-learning model 1218 implements a neural network 1242 capable of performing, for example, classification and clustering operations. In other examples, the training phase 1220 can involve deep learning, in which the training data 1222 is unstructured, and the trained machine-learning model 1218 implements a deep neural network 1242 that can perform both feature extraction and classification/clustering operations.

In some examples, a neural network 1242 can be generated during the training phase 1220, and implemented within the trained machine-learning model 1218. The neural network 1242 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 1242 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1242 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1220, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 1226, the trained machine-learning model 1218 uses the features 1224 for analyzing inference data 1244 to generate inferences, outcomes, or predictions, as examples of a prediction/inference data 1238. For example, during prediction phase 1226, the trained machine-learning model 1218 generates an output. Inference data 1244 is provided as an input to the trained machine-learning model 1218, and the trained machine-learning model 1218 generates the prediction/inference data 1238 as output, responsive to receipt of the inference data 1244.

In some examples, the trained machine-learning model 1218 can be a generative AI model. Generative AI is a term that can refer to any type of artificial intelligence that can create new content from training data 1222. For example, generative AI can produce text, images, video, audio, code, or synthetic data similar to the original data but not identical. In cases where the trained machine-learning model 1218 is a generative AI, inference data 1244 can include text, audio, image, video, numeric, or media content prompts and the output prediction/inference data 1238 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

Described implementations of the subject matter can include one or more features, alone or in combination as illustrated below by way of example.

Example 1 is a machine-implemented method, comprising: capturing, using one or more tracking sensors of an eXtended Reality (XR) system, tracking data of a hand of a user of the XR system; generating a hand model using the tracking data, the hand model including a set of joints; transforming the set of joints into a normalized coordinate system; applying a set of constraints to one or more joints of the set of joints; generating a user interface using the hand model; and causing display of the user interface to the user.

In Example 2, the subject matter of Example 1 includes, wherein transforming the positions of the set of joints into the normalized coordinate system comprises: grouping a subset of the set of joints into one or more sets of finger joints, each set of finger joints corresponding a finger of the hand model; defining a palm coordinate frame with an X axis, a Y axis, and a Z axis based on a palm orientation of the hand model; and defining, using a base finger joint of each set of finger joints, a respective local coordinate frame for each set of finger joints.

In Example 3, the subject matter of any of Example 1-2 includes, wherein transforming the positions of the set of joints into the normalized coordinate system further comprises: orienting the Y axis of the palm coordinate frame to point through a set of finger joints corresponding to a middle finger of the hand model.

In Example 4, the subject matter of any of Examples 1-3 includes, wherein applying the set of constraints comprises: translating one or more finger joints of one or more sets of finger joints to form a piecewise linear arrangement in a two-dimensional space in the respective local coordinate frame of the one or more sets of finger joints.

In Example 5, the subject matter of any of Examples 1-4 includes, wherein the hand model further comprises a set of bone segments, and wherein the machine-implemented method further comprises maintaining a statistical model of a respective bone segment length for each bone segment of the set of bone segments.

In Example 6, the subject matter of any of Example 1-5 includes, wherein maintaining the statistical model comprises: calculating respective running averages of observed bone segment lengths for one or more bone segments of the set of bone segments; and adjusting current bone segment lengths for the one or more bone segments of the set of bone segments based on the respective running averages.

In Example 7, the subject matter of any of Examples 1-6 includes, wherein the XR system is a head-wearable apparatus.

In Example 8, the subject matter of any of Examples 1-7 includes, adapting the hand model to individual user characteristics.

In Example 9, the subject matter of any of Examples 1-8 includes, wherein adapting the hand model comprises: updating at least one of bone lengths, joint angle limits, or hand shape parameters based on observed hand configurations over multiple tracking sessions.

In Example 10, the subject matter of any of Examples 1-9 includes, using a finger twisting model to determine a natural hand closure towards a point.

In Example 11, the subject matter of any of Examples 1-10 includes, applying corrections the hand model consistently across multiple tracking frames.

In Example 12, the subject matter of any of Examples 1-11 includes, maintaining user-specific hand statistics for a predetermined time period.

In Example 13, the subject matter of any of Examples 1-12 includes, generating a mesh representation of the hand based on the hand model.

In Example 14, the subject matter of any of Examples 13 includes, using the mesh representation for at least one of: overlaying on a user's real hand, displaying fingertip positions, or calculating occlusions in an XR user interface.

In Example 15, the subject matter of any of Examples 1-14 includes, wherein applying constraints comprises: enforcing anatomically correct ranges of motion for each joint of the set of joints.

Example 16 is at least one machine-readable medium including instructions that, when executed by processing circuitry, cause the processing circuitry to perform operations to implement any of Examples 1-15.

Example 17 is an apparatus comprising means to implement any of Examples 1-15.

Example 18 is a system to implement any of Examples 1-15.

Example 19 is a method to implement any of Examples 1-15.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### Term Examples

As used in this disclosure, phrases of the form “at least one of an A, a B, or a C,” “at least one of A, B, or C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium”mean the same thing and can be used interchangeably in this disclosure.

“User device” can include, for example, a device accessed, controlled or owned by a user and with which the user interacts perform an action, engagement or interaction on the user device, including an interaction with other users or computer systems.

What is claimed is:

1. A machine-implemented method, comprising:
capturing, using one or more tracking sensors of an eXtended Reality (XR) system, tracking data of a hand of a user of the XR system;
generating a hand model using the tracking data, the hand model including a set of joints;
transforming the set of joints into a normalized coordinate system;
applying a set of constraints to one or more joints of the set of joints;
generating a user interface using the hand model; and
causing display of the user interface to the user.

2. The machine-implemented method of claim 1, wherein transforming the set of joints into the normalized coordinate system comprises:
grouping a subset of the set of joints into one or more sets of finger joints, each set of finger joints corresponding a finger of the hand model;
defining a palm coordinate frame with an X axis, a Y axis, and a Z axis based on a palm orientation of the hand model; and
defining, using a base finger joint of each set of finger joints, a respective local coordinate frame for each set of finger joints.

3. The machine-implemented method of claim 2, wherein transforming the set of joints into the normalized coordinate system further comprises:
orienting the Y axis of the palm coordinate frame to point through a set of finger joints corresponding to a middle finger of the hand model.

4. The machine-implemented method of claim 2, wherein applying the set of constraints comprises:
translating one or more finger joints of one or more sets of finger joints to form a piecewise linear arrangement in a two-dimensional space in the respective local coordinate frame of the one or more sets of finger joints.

5. The machine-implemented method of claim 1,
wherein the hand model further comprises a set of bone segments, and
wherein the machine-implemented method further comprises maintaining a statistical model of a respective bone segment length for each bone segment of the set of bone segments.

6. The machine-implemented method of claim 5, wherein maintaining the statistical model comprises:
calculating respective running averages of observed bone segment lengths for one or more bone segments of the set of bone segments; and
adjusting current bone segment lengths for the one or more bone segments of the set of bone segments based on the respective running averages.

7. The machine-implemented method of claim 1, wherein the XR system is a head-wearable apparatus.

8. A machine comprising:
at least one processor; and
at least one memory storing instructions that, when executed by the at least one processor, cause the machine to perform operations comprising:
capturing, using one or more tracking sensors of an eXtended Reality (XR) system, tracking data of a hand of a user of the XR system;
generating a hand model using the tracking data, the hand model including a set of joints;
transforming the set of joints into a normalized coordinate system;
applying a set of constraints to one or more joints of the set of joints;
generating a user interface using the hand model; and
causing display of the user interface to the user.

9. The machine of claim 8, wherein transforming the set of joints into the normalized coordinate system comprises:
grouping a subset of the set of joints into one or more sets of finger joints, each set of finger joints corresponding a finger of the hand model;
defining a palm coordinate frame with an X axis, a Y axis, and a Z axis based on a palm orientation of the hand model; and
defining, using a base finger joint of each set of finger joints, a respective local coordinate frame for each set of finger joints.

10. The machine of claim 9, wherein transforming the set of joints into the normalized coordinate system further comprises:
orienting the Y axis of the palm coordinate frame to point through a set of finger joints corresponding to a middle finger of the hand model.

11. The machine of claim 9, wherein applying the set of constraints comprises:
translating one or more finger joints of one or more sets of finger joints to form a piecewise linear arrangement in a two-dimensional space in the respective local coordinate frame of the one or more sets of finger joints.

12. The machine of claim 8,
wherein the hand model further comprises a set of bone segments, and
wherein the operations further comprise maintaining a statistical model of a respective bone segment length for each bone segment of the set of bone segments.

13. The machine of claim 12, wherein maintaining the statistical model comprises:
calculating respective running averages of observed bone segment lengths for one or more bone segments of the set of bone segments; and
adjusting current bone segment lengths for the one or more bone segments of the set of bone segments based on the respective running averages.

14. The machine of claim 8, wherein the XR system is a head-wearable apparatus.

15. A machine-storage medium, the machine-storage medium including instructions that, when executed by a machine, cause the machine to perform operations comprising:
capturing, using one or more tracking sensors of an eXtended Reality (XR) system, tracking data of a hand of a user of the XR system;
generating a hand model using the tracking data, the hand model including a set of joints;
transforming the set of joints into a normalized coordinate system;
applying a set of constraints to one or more joints of the set of joints;
generating a user interface using the hand model; and
causing display of the user interface to the user.

16. The machine-storage medium of claim 15, wherein transforming the set of joints into the normalized coordinate system comprises:
grouping a subset of the set of joints into one or more sets of finger joints, each set of finger joints corresponding a finger of the hand model;
defining a palm coordinate frame with an X axis, a Y axis, and a Z axis based on a palm orientation of the hand model; and
defining, using a base finger joint of each set of finger joints, a respective local coordinate frame for each set of finger joints.

17. The machine-storage medium of claim 16, wherein transforming the set of joints into the normalized coordinate system further comprises:
orienting the Y axis of the palm coordinate frame to point through a set of finger joints corresponding to a middle finger of the hand model.

18. The machine-storage medium of claim 16, wherein applying the set of constraints comprises:
translating one or more finger joints of one or more sets of finger joints to form a piecewise linear arrangement in a two-dimensional space in the respective local coordinate frame of the one or more sets of finger joints.

19. The machine-storage medium of claim 15,
wherein the hand model further comprises a set of bone segments, and
wherein the operations further comprise maintaining a statistical model of a respective bone segment length for each bone segment of the set of bone segments.

20. The machine-storage medium of claim 19, wherein maintaining the statistical model comprises:
calculating respective running averages of observed bone segment lengths for one or more bone segments of the set of bone segments; and
adjusting current bone segment lengths for the one or more bone segments of the set of bone segments based on the respective running averages.
